(19) United States
(12) Patent Application Publication
(10) Pub. No.: US 2022/0255774 A1
(43) Pub. Date: Aug. 11, 2022

(54) WIRELESS NETWORKS BASED ON MULTIPLE BASIC SERVICE SET IDENTIFIERS

(71) Applicant: HEWLETT PACKARD ENTERPRISE DEVELOPMENT LP, Houston, TX (US)

(72) Inventors: XUGUANG JIA, Beijing (CN); Abhiruchi Dakshinkar, Santa Clara, CA (US); Qiang Zhou, Santa Clara, CA (US)

(21) Appl. No.: 17/173,156

(22) Filed: Feb. 10, 2021

(51) Int. Cl. H04L 12/66; H04L 12/46

(52) U.S. Cl. CPC H04L 12/66; H04L 12/4641

(57) ABSTRACT

Systems and methods are provided for using multiple MBSSIDs associated with groups of VAPs for an AP. The groups of VAPs can be determined for an AP based on various characteristics that separate one group of VAPs from another group of VAPs. Each group of VAPs can be associated with an MBSSID based on the BSSIDs of the VAPs in the group of VAPs. The AP can broadcast the MBSSIDs of each group of VAPs instead of broadcasting an MBSSID for all VAPs associated with the AP.

### DESCRIPTION OF RELATED ART

In wireless networks, client devices or stations (STAB) wirelessly connect to a network through an access point (AP). The AP connects to a wired network and facilitates use of the wired network by the client devices that are wirelessly connected to the AP. As use wireless networking technologies increases, density in wireless networks also increases. This density, among other factors, create various challenges in the field of wireless networking. The Institute of Electrical and Electronics Engineers (IEEE) has issued various standards, such as the 802.11 standard to address various challenges in the field of wireless networking. Nevertheless, wireless networking technologies continue to face challenges as the use of wireless networking technologies increases.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1A illustrates an example wireless network deployment in which one or more Multiple Basic Service Set Identifiers (MBSSIDs) for groups of Virtual Access Points (VAPs) may be implemented.

FIG. 1B illustrates an example access point (AP) in which one or more MBSSIDs for groups of VAPs may be implemented.

FIG. 2 illustrates an example computing component for effectuating generation of multiple MBSSIDs for groups of VAPs, in accordance with one embodiment.

FIG. 3A illustrates an example MBSSID beacon and an example MBSSID element, in accordance with one embodiment.

FIG. 3B illustrates example MBSSID elements, in accordance with one embodiment.

FIG. 4A illustrates example configurations in which one or more MBSSIDs for groups of VAPs may be implemented, in accordance with one embodiment.

FIG. 4B illustrates example timing diagrams, in accordance with one embodiment.

FIG. 5 is an example computing component that may be used to implement various features of embodiments described in the present disclosure.

The figures are not exhaustive and do not limit the present disclosure to the precise form disclosed.

### DETAILED DESCRIPTION

The use of Virtual Access Points (VAPs) allows an Access Point (AP) to present itself as multiple APs. To client devices or stations (STAs), each VAP appears as a separate AP. Each VAP can be associated with its own set of network properties, such as authentication and encryption, and each set of network properties can be indicated by a Basic Service Set Identifier (BSSID). Thus, each VAP can be associated with a BSSID that indicates the set of network properties associated with the VAP. The AP broadcasts these BSSIDs as beacon frames to announce the presence of the VAPs. The beacon frames are broadcasted to the STAs, which use the BSSIDs associated with the beacon frames to determine a VAP with which to connect. As wireless technologies advance, APs become capable of supporting greater numbers of VAPs. In cases where an AP supports multiple wireless networks using multiple VAPs, broadcasting a separate BSSID as a separate beacon frame for each VAP can be inefficient and degrade the connection quality of the wireless networks.

The use of Multiple Basic Service Set Identifiers (MBSSIDs) allows multiple BSSIDs associated with VAPs provided by an AP to be combined into an MBSSID that the AP broadcasts. The MBSSID compacts the information associated with the multiple BSSIDs in a manner that allows STAs to determine the network properties for each VAP associated with each BSSID. Broadcasting an MBSSID allows the AP to use fewer beacon frames than the AP would by broadcasting separate BSSIDs. As APs become capable of supporting greater numbers of VAPs, APs use greater numbers of beacon frames to deliver MBSSIDs. This can be inefficient as STAs wait until multiple beacon frames are received in order to determine the network properties of each VAP and determine a VAP with which to connect.

Accordingly, disclosed are methods and systems for providing multiple MBSSIDs associated with groups of VAPs for an AP. The groups of VAPs can be determined for an AP based on various characteristics that separate one group of VAPs from another group of VAPs. These characters can include, but are not limited to, MAC capability, mesh capability, network zones, target wake time (TWT), etc. Each group of VAPs can be associated with an MBSSID based on the BSSIDs of the VAPs in the group of VAPs. The AP can broadcast the MBSSIDs of each group of VAPs instead of broadcasting an MBSSID for all VAPs associated with the AP. Broadcasting multiple MBSSIDs associated with groups of VAPs for an AP provides for various advantages over broadcasting an MBSSID for all VAPs associated with the AP, as further described herein.

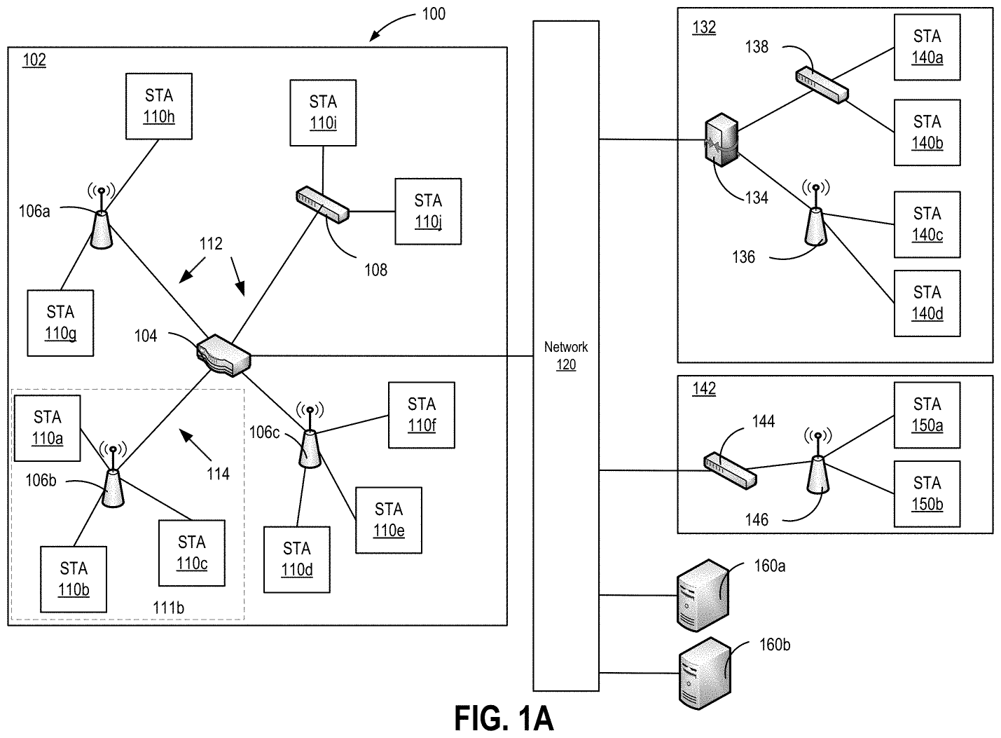

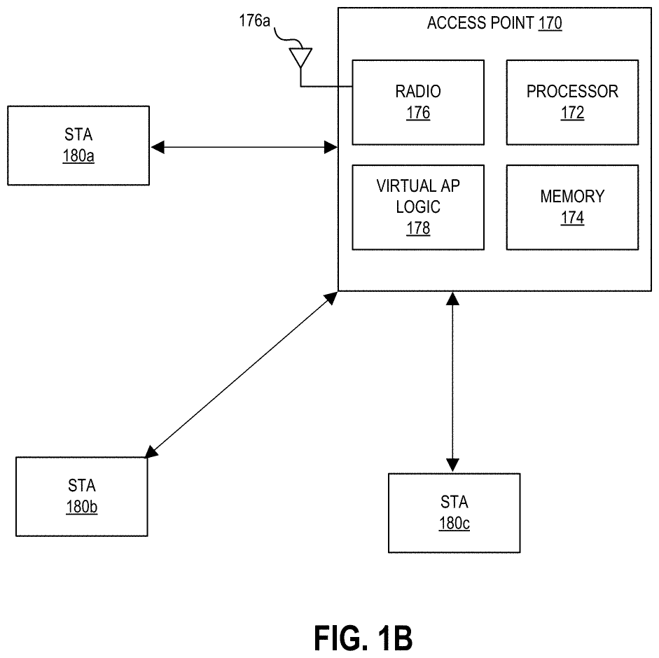

Before describing embodiments of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. This diagram illustrates an example of a configuration implemented with an organization having multiple users (or at least multiple client devices 110) and possibly multiple physical or geographical sites 102, 132, 142. The network configuration 100 may include a primary site 102 in communication with a network 120. The network configuration 100 may also include one or more remote sites 132, 142, that are in communication with the network 120.

The primary site 102 may include a primary network, which can be, for example, an office network, home network or other network installation. The primary site 102 network may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though it may not be the only point of communication with the network 120 for the primary site 102. A single controller 104 is illustrated, though the primary site may include multiple controllers and/or multiple communication points with network 120. In some embodiments, the controller 104 communicates with the network 120 through a router (not illustrated). In other embodiments, the controller 104 provides router functionality to the devices in the primary site 102.

A controller 104 may be operable to configure and manage network devices, such as at the primary site 102, and may also manage network devices at the remote sites 132, 134. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (Aps) 106a-c. Switches 108 and wireless APs 106a-c provide network connectivity to various client devices 110a-j. Using a connection to a switch 108 or AP 106a-c, a client device 110a-j may access network resources, including other devices on the (primary site 102) network and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the primary site 102, a switch 108 is included as one example of a point of access to the network established in primary site 102 for wired client devices 110i-j. Client devices 110i-j may connect to the switch 108 and through the switch 108, may be able to access other devices within the network configuration 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in primary site 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

The network configuration 100 may include one or more remote sites 132. A remote site 132 may be located in a different physical or geographical location from the primary site 102. In some cases, the remote site 132 may be in the same geographical location, or possibly the same building, as the primary site 102, but lacks a direct connection to the network located within the primary site 102. Instead, remote site 132 may utilize a connection over a different network, e.g., network 120. A remote site 132 such as the one illustrated in FIG. 1A may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 provide connectivity to the network for various client devices 140a-d.

In various embodiments, the remote site 132 may be in direct communication with primary site 102, such that client devices 140a-d at the remote site 132 access the network resources at the primary site 102 as if these client devices 140a-d were located at the primary site 102. In such embodiments, the remote site 132 is managed by the controller 104 at the primary site 102, and the controller 104 provides the necessary connectivity, security, and accessibility that enable the remote site 132's communication with the primary site 102. Once connected to the primary site 102, the remote site 132 may function as a part of a private network provided by the primary site 102.

In various embodiments, the network configuration 100 may include one or more smaller remote sites 142, comprising only a gateway device 144 for communicating with the network 120 and a wireless AP 146, by which various client devices 150a-b access the network 120. Such a remote site 142 may represent, for example, an individual employee's home or a temporary remote office. The remote site 142 may also be in communication with the primary site 102, such that the client devices 150a-b at remote site 142 access network resources at the primary site 102 as if these client devices 150a-b were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 130 to 142 as well as access to servers 160a-b. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers 160a-b. Content servers 160a-b may include various providers of multimedia downloadable and/or streaming content, including audio, video, graphical, and/or text content, or any combination thereof. Examples of content servers 160a-b include, for example, web servers, streaming radio and video providers, and cable and satellite television providers. The client devices 110a j, 140a-d, 150a-b may request and access the multimedia content provided by the content servers 160a-b.

Although only 10 client devices 110a-j, or stations (STAs), are illustrated at primary site 102 in the example of FIG. 1A, in various applications, a network may include dramatically larger quantities of STAs. For example, various wireless networks may include hundreds, thousands, or even tens of thousands of STAs communicating with their respective APs, potentially at the same time. As noted above, various IEEE 802.11 networks may implement what is referred to as BSS coloring to increase network capacity in such dense environments. This can allow improvement and frequency reuse among network devices. As also noted above, networks implementing BSS coloring may further allow a fall back to an alternative color where the primary or default color assignment results in a BSS color conflict. Because it may be time-consuming to identify an appropriate alternative color when a BSS color conflict occurs, conventional fallback approaches may introduce undesired amounts of latency or delay in the process. Accordingly, various embodiments of the systems and methods disclosed herein may provide predetermination of alternative color plans so that a fallback color determination is already made in advance, before the BSS color conflict occurs. In some applications, the BSS color computation and assignment may be made on a global basis for the STAs in the network.

FIG. 1B is a schematic representation of an example AP 170 in accordance with one embodiment. AP 170 may be a network device that can include, e.g., one or more of: a processor 182, memory/data storage 174, a radio 176 (and corresponding antenna 176a), and virtual AP (VAP) logic 178.

Memory 174 may include a fast read-write memory for storing programs and data during the AP 180's operations and a hierarchy of persistent memory such as ROM, EPROM, and Flash memory for storing instructions and data needed for the startup and/or operations of AP 170. Memory 174 may store data that is to be transmitted from AP 170 or data that is received by AP 170. Memory 174 may store one or more of the various parameters (and values thereof) described herein. In some embodiments, memory 174 is a distributed set of data storage components. Although not shown, it should be understood that AP 170 may further include input/output interfaces, including wired network interfaces such as IEEE 802.3 Ethernet interfaces, as well as wireless network interfaces such as IEEE 802.11 Wi-Fi interfaces, although examples of the disclosure are not limited to such interfaces.

Processor 172 is coupled to at least memory 174. Processor 172 may be any processing device including, but not limited to a MIPS-class processor, a microprocessor, a digital signal processor, an application specific integrated circuit, a microcontroller, a state machine, or any type of programmable logic array.

Radio 176 may be a 5 GHZ radio, a 2.4 GHZ radio, a 6 GHz radio, or other appropriate wireless communications component for effectuating wireless communications. Radio 176 may be configured to both transmit and receive data. Radio 176 may facilitate communication with client devices/STAs 180a, 180b, 180c. For example, radio 176 may operate on a communication band (e.g., 5.0 GHz UNII band) and operate in accordance with a particular wireless specification (e.g., 802.11ax). It should be understood that AP 170 may have a plurality of radios (physical and/or logical), and may have dedicated or shared channels for each radio or group(s) of radios.

In some embodiments, VAP logic 178 may include one or more functional units implemented using firmware, hardware, software, or a combination thereof for configuring VAPs associated with AP 170 and/or STAs 180a, 180b, 180c for the transmission of data/frames to and from AP 170. Although, VAP logic 178 is shown as being implemented on AP 170, one or more physical or functional components of the prioritization logic 178 may be implemented on a separate device, such as an AP controller, an example of which may be controller 104 of FIG. 1A.

As an illustrative example, VAP logic 178 may implement three VAPs associated with AP 170. STAs 180a, 180b, 180c may identify the three VAPs as separate APs with different capabilities. STAs 180a, 180b, 180c may connect to the three VAPs based on these different capabilities. In this example, STA 180a may connect to a first VAP, STA 180b may connect to a second VAP, and STA 180c may connect to a third VAP. In some cases, each VAP may be associated with its own Virtual Local Area Network (VLAN). In these cases, STA 180a may be connected to a first VLAN associated with the first VAP, STA 180b may be connected to a second VLAN associated with the second VAP, and STA 180c may be connected to a third VLAN associated with the third VAP. As STAs 180a, 180b, 180c are connected to different VLANs associated with different VAPs, STAs 180a, 180b, 180c operate as if they are connected to different APs even though they are communicating with AP 170.

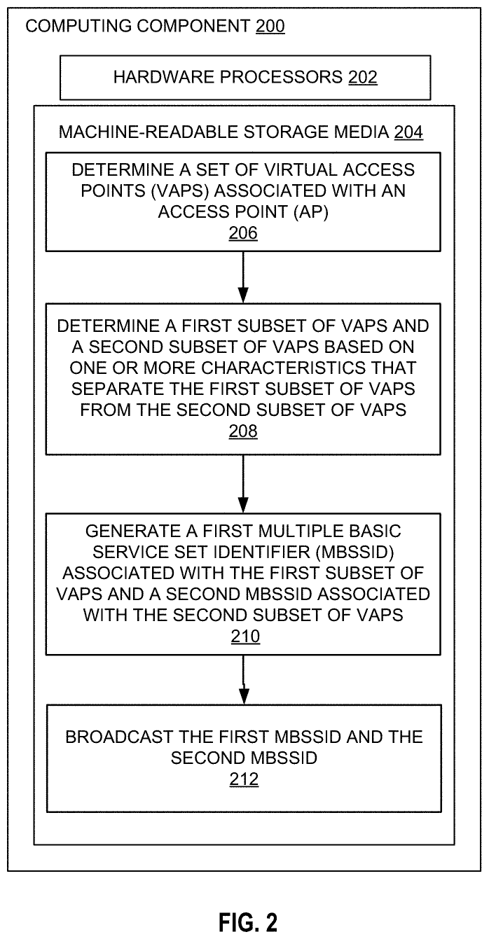

FIG. 2 is a block diagram of an example computing component or device 200 for generating one or more MBSSIDs for groups of VAPs in accordance with one embodiment. Computing component 200 may be, for example, a server computer, a controller, or any other similar computing component capable of processing data. In the example implementation of FIG. 2, the computing component 200 includes a hardware processor, 202, and machine-readable storage medium, 204. In some embodiments, computing component 200 may be an embodiment of an AP or AP controller, e.g., AP 106b or AP controller 104, respectively, or a component of network 120 of FIG. 1A, for example.

Hardware processor 202 may be one or more central processing units (CPUs), semiconductor-based microprocessors, and/or other hardware devices suitable for retrieval and execution of instructions stored in machine-readable storage medium, 204. Hardware processor 202 may fetch, decode, and execute instructions, such as instructions 206-212, to control processes or operations for generating one or more MBSSIDs for groups of VAPs. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits. Instructions 206-212 can allow for generating one or more MBSSIDs for groups of VAPs. Although instructions 206-212 are shown, it can be understood that the instructions can be performed in any order, without some of the instructions shown, and/or with the inclusion of other instructions not shown, and the instructions would still fall within the scope of the disclosure.

A machine-readable storage medium, such as machine-readable storage medium 304, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 202 may be a non-transitory storage medium, where the term “non-transitory” does not encompass transitory propagating signals. As described in detail below, machine-readable storage medium 202 may be encoded with executable instructions, for example, instructions 206-212, for generating one or more MBSSIDs for groups of VAPs.

Hardware processor 200 may execute instruction 206 to determine a set of Virtual Access Points (VAPs) associated with an Access Point (AP). An AP provides for wireless connectivity between client devices or stations (STAB) and a wired network. The AP broadcasts beacon frames advertising the AP capabilities, and the client devices use the beacon frames to determine information for connecting to the AP. The AP can provide for multiple VAPs. VAPs appear over the air as multiple APs. For example, an AP may support up to sixteen VAPs. These VAPs appear over the air as sixteen APs. The VAPs can be associated with different characteristics or capabilities, such as authentication, encryption, and bandwidth. Through the use of VAPs, different services can be provided to different client devices through the same AP.

Hardware processor 200 may execute instruction 208 to determine a first subset of VAPs and a second subset of VAPs based on one or more characteristics that separate the first subset of VAPs from the second subset of VAPs. Determining different subsets or groups of VAPs associated with an AP can avoid relying on one MBSSID that spans multiple beacon frames to broadcast information for the VAPS. Different MBSSID grouping schemes can be suitable for different scenarios and address different issues. For example, VAPs can be grouped based on MAC capability, mesh capability, network zones, and/or target wake time (TWT).

In some embodiments, VAPs can be grouped based on MAC capabilities. An AP may be able to facilitate various MAC capabilities, and various client devices may vary with regard to which MAC capabilities they support. The AP can use VAPs to facilitate communication with the various client devices based on their MAC capabilities. MAC capabilities can include, for example, Multiple-Input Multiple-Output (MIMO), Multi-User Multi-Input Multiple-Output (MU-MIMO), Orthogonal Frequency-Division Multiple Access (OFDMA), High Efficiency Multi-User Orthogonal Frequency-Division Multiple Access (HE MU-OFDMA), dynamic fragmentation level, supported Modulation and Coding Scheme (MCS), and Basic Service Set (BSS) Color. In various scenarios, client devices with certain MAC capabilities will look to connect with VAPs that support those MAC capabilities. In these scenarios, grouping VAPs based on their supported MAC capabilities and providing MBSSIDs associated with the VAP groups allows client devices to quickly discover the VAP group that complements their supported MAC capabilities. For example, an AP that supports HE MU-OFDMA can provide a set of VAPs that include VAPs that support HE MU-OFDMA and VAPs that do not support HE MU-OFDMA. The set of VAPs can be divided into a first subset of the VAPs that have clients supporting HE MU-OFDMA and a second subset of the VAPs that do not have clients supporting HE MU-OFDMA. A first MBSSID can be generated for the first subset of the VAPs and a second MBSSID can be generated for the second subset of the VAPs. In this example, a client device that lacks HE MU-OFDMA capabilities may receive the first MBSSID and the second MBSSID. The client device lacks HE MU-OFDMA capabilities, so the client device can determine a VAP with which to connect based on the second MBSSID, which provides information for the VAPs that do not support HE MU-OFDMA. As another example, an AP that supports multiple operating bandwidths, 20 MHz and 80 MHz, can provide a set of VAPs that uses either 20 MHz or 80 MHz as their operating bandwidth. The set of VAPs can be divided into a first subset of the VAPs that use 20 MHz as their operating bandwidth and a second subset of the VAPs that use 80 MHz as their operating bandwidth. A first MBSSID can be generated for the first subset of the VAPs and a second MBSSID can be generated for the second subset of the VAPs. In this example, a client device that supports the 20 MHz operating bandwidth but does not support the 80 MHz operating bandwidth may receive the first MBSSID and the second MBSSID. The client device can determine a VAP that uses the 20 MHz operating bandwidth and connect to the VAP based on the first MBSSID.

In some embodiments, VAPs can be grouped based on mesh capabilities. A mesh is a wireless point to point connection between multiple APs. The APs can provide mesh VAPs that utilize the wireless point to point connection, or the mesh. Maintaining the mesh can be relatively demanding as it involves a connection between multiple APs. In some cases, interruptions in an AP that is part of a mesh can cause interruptions to the rest of the mesh. As such, it may be advantageous in certain scenarios to group VAPs based on mesh capabilities. In these scenarios, grouping VAPs based on whether they are part of a mesh and providing MBSSIDs associated with the VAP groups can counteract interruptions to the mesh by VAPs that are not part of the mesh. For example, an AP may be a part of a mesh with other APs. The AP may provide a set of VAPs that include a subset of VAPs that are a part of the mesh and a subset of VAPs that are not part of the mesh. A first MBSSID can be associated with the subset of VAPs that are a part of the mesh, and a second MBSSID can be associated with the subset of VAPs that are not part of the mesh. In this example, if a change is implemented to one of the VAPs that are not part of the mesh, then the second MBSSID, which is associated with the subset of VAPs that are not part of the mesh can be updated without interruptions to the first MBSSID.

In some embodiments, VAPs can be grouped based on priority. In some cases, an AP can provide VAPs associated with different priorities. Some of the VAPs may be prioritized higher than other VAPs. In these cases, VAPs that are prioritized higher can be separated from VAPs that are prioritized lower. The VAPs that are prioritized lower can be grouped together. By separating VAPs that are prioritized higher and assigning the separate VAPs separate MBSSIDs, the BSSID associated with the higher priority VAPs do not inherit from and are not inherited from the BSSIDs associated with the lower priority VAPs. When a change is made to a VAP in a group of lower priority VAPs, the MBSSID associated with the group of lower priority VAPs changes. This can result in interruptions to the lower priority VAPs. The MBSSIDs associated with the higher priority VAPs, which are separate from the lower priority VAPs are not interrupted. For example, an AP can provide a VAP for critical network services that the AP provides. The AP can also provide a group of VAPs for non-critical network services. The group of VAPs for the non-critical network services can be grouped, and an MBSSID can combine the BSSIDs of this group of VAPs. An MBSSID for the VAP for critical network services can be separate. In this example, if a change is made to one of the VAPs for the non-critical network services, the MBSSID for the group of VAPs for the non-critical network services can be changed and may result in an interruption to the group of VAPs. The VAP for critical network services may be unaffected by the interruption.

In some embodiments, VAPs can be grouped based on network zones. In some cases, an AP can provide VAPs associated with different network zones. For example, an AP may be shared by multiple enterprises or entities, and each enterprise can be associated with its respective network zone. The AP may provide VAPs associated with each network zone, allowing each enterprise to operate in their own respective network zones while sharing the AP. In some cases, VAPs associated with different network zones may have different configurations such that using an MBSSID that combines the BSSIDs of all the VAPs would be inefficiently long. The MBSSID would serve to indicate that enterprises associated with the different network zones are operating in close physical proximity. Also, if one enterprise chooses to implement changes to their network zone, the MBSSID would be affected for all enterprises associated with the different network zones. As such, it may be advantageous to group VAPs based on network zones. In these scenarios, grouping VAPs based on network zones and providing MBSSIDs associated with the VAP groups provides for separation between the network zones. For example, two enterprises can share an AP. The AP can provide a set of VAPs that includes a subset of VAPs associated with a first enterprise in a first zone, and a subset of VAPs associated with a second enterprise in a second zone. A first MBSSID can be associated with the subset of VAPs for the first enterprise. A second MBSSID can be associated with the subset of VAPs for the second enterprise. Client devices associated with the first enterprise would utilize the first MBSSID to determine a VAP with which to connect. Likewise, client devices associated with the second enterprise would utilize the second MBSSID to determine a VAP with which to connect. In this example, if a change is implemented to the VAPs for the second enterprise, the change would not impact the first MBSSID, which is associated with the VAPs for the first enterprise.

In some embodiments, VAPs can be grouped based on broadcast target wake time (BTWT) or a BTWT session parameter. Client devices can individually negotiate a target wake time (TWT) with an AP. The TWT is a time interval or set of times for a client device to access a wireless network. BTWT is negotiated with a group of client devices and is a time interval or set of times for the group of client devices to access a wireless network. BTWT can be a factor in power saving for various client devices. For example, some client devices rely on battery power and implement various power saving functionalities to preserve the battery power. These client devices may negotiate with an AP for longer BTWT in order to have longer sleep intervals and preserve more battery power. For client devices such as these, an MBSSID that includes VAPs that do not facilitate these power saving functionalities can create challenges in terms of power consumption. For example, client devices that do not implement power saving, such as desktop computer, may try to negotiate a shorter BTWT. As such, it may be advantageous to group VAPs based on BTWT. Grouping VAPs based on BTWT and providing MBSSIDs for the VAP groups allows client devices to join a VAP that complements their power saving functionalities. Grouping VAPs based on BTWT can facilitate faster discovery for different VAPs from multiple MBSSIDs. Grouping VAPs based on BTWT also allows the MBSSIDs for the VAP groups to be broadcasted at different intervals, which can alleviate network congestion. For example, an AP can provide a set of VAPs that includes VAPs used by low power client devices and VAPs used by other client devices. The set of VAPs can be divided into a first subset of VAPs that are used by the low power client devices and a second subset of VAPs that are used by the other client devices. A first MBSSID can be generated for the first subset of the VAPs and a second MBSSID can be generated for the second subset of the VAPs. In this example, the first MBSSID can be broadcast at a higher BTWT than the second MBSSID, which allows the low power client devices to sleep for a longer duration, potentially saving more power. The second MBSSID can be broadcast at a lower BTWT and support a relatively higher communication throughput at the cost of higher power consumption. In this example, low power client devices can connect to a VAP using the first MBSSID, which can complement their own power saving functionalities.

In some cases, an AP can operate in an Enhanced MBSSID Advertisement (EMA) mode when information for VAPs provided by the AP cannot be advertised in a single beacon. In these cases, the information for VAPs is spread over multiple beacons. Information for a particular VAP is present every p beacons, where p is the profile periodicity of the MBSSID associated with the VAPs. Additionally, the AP periodically multicasts data to client devices at a Delivery Traffic Indication Message (DTIM) period (or DTIM interval). The DTIM period can be based on the profile periodicity and a beacon interval for the AP (e.g., profile periodicity multiplied by the beacon interval). Low power client devices generally wake to receive multicast data based on the DTIM period. The AP buffers data during the DTIM period and transmits the buffered data at each DTIM interval. In these cases, a long DTIM period can cause buffer overflow and loss of data at an AP. Further, multicasting a large amount of buffered data can consume a large amount of airtime, causing latency issues. Thus, in cases where an MBSSID spans over multiple beacons, a longer DTIM period can result in issues such as data loss and latency. By using multiple MBSSIDs for VAPs of an AP, each MBSSID can span fewer beacons (e.g., one beacon) and can be associated with a shorter DTIM period. This provides for increased efficiency and avoids data loss at the AP.

Hardware processor 200 may execute instruction 210 to generate a first Multiple Basic Service Set Identifier (MBSSID) associated with the first subset of VAPs and a second MBSSID associated with the second subset of VAPs. An MBSSID combines BSSIDs using inheritance. The MBSSID includes a transmitted BSSID of a transmitted VAP. The transmitted BSSID includes information elements for the characteristics of the transmitted VAP. The MBSSID also includes non-transmitted BSSIDs of non-transmitted VAPs. The non-transmitted BSSIDs include information elements that indicate which of the characteristics of the transmitted VAP are inherited in the non-transmitted VAPs and which of the characteristics of the transmitted VAP are not inherited in the non-transmitted VAPs. In some cases, an AP can provide VAPs that have many different characteristics. In these cases, using one MBSSID for the VAPs can result in a larger MBSSID that spans multiple beacon frames. As such, it may be advantageous to group the VAPs and generate an MBSSID for each of the VAP groups. Grouping the VAPs based on the various characteristics described herein can facilitate MBSSIDs of groups of VAPs that share characteristics, allowing the MBSSID beacons to be shorter than an MBSSID that is used for all the VAPs.

Hardware processor 200 may execute instruction 212 to broadcast the first MBSSID and the second MBSSID. An AP broadcasts an MBSSID in one or more beacon frames. The AP can broadcast the MBSSID at regular beacon intervals. Beacon intervals can be adjusted and vary depending on various factors. In general, a higher beacon interval can use less communication throughput from the AP than a lower beacon interval. A higher beacon interval can also cause a slower delivery of an MBSSID than a lower beacon interval in cases where the MBSSID spans multiple beacon frames. In cases where an MBSSID spans multiple beacon frames, the BSSID for a specific VAP is available only once every p beacon intervals, where p is the profile periodicity. An advantage of using multiple MBSSIDs here is that each MBSSID can be broadcast at respective beacon intervals. This facilitates fast discovery of VAPs through the MBSSIDs and avoids cases where a client device waits on multiple beacon frames to receive an MBSSID. This fast discovery can be especially useful for roaming client devices.

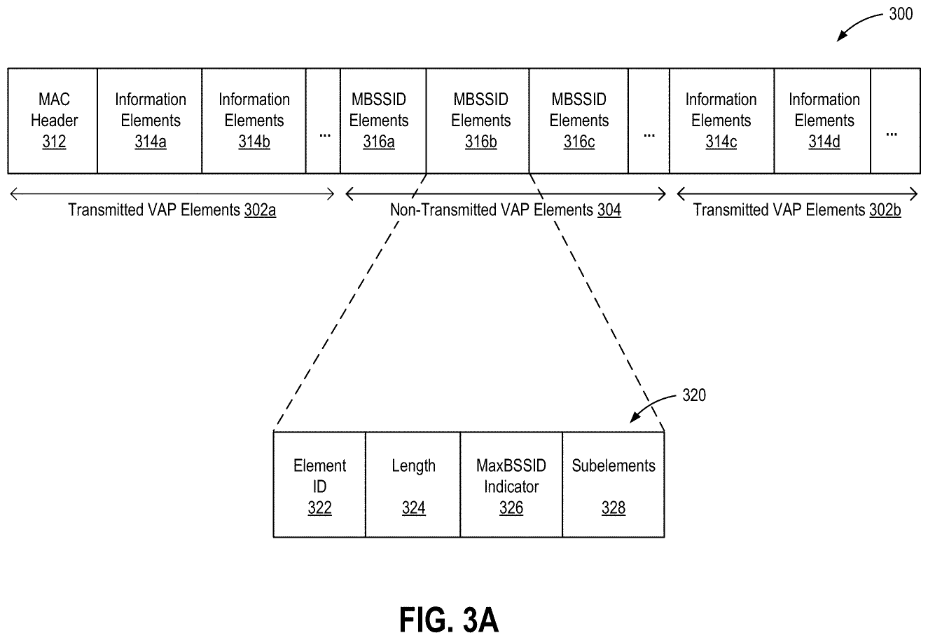

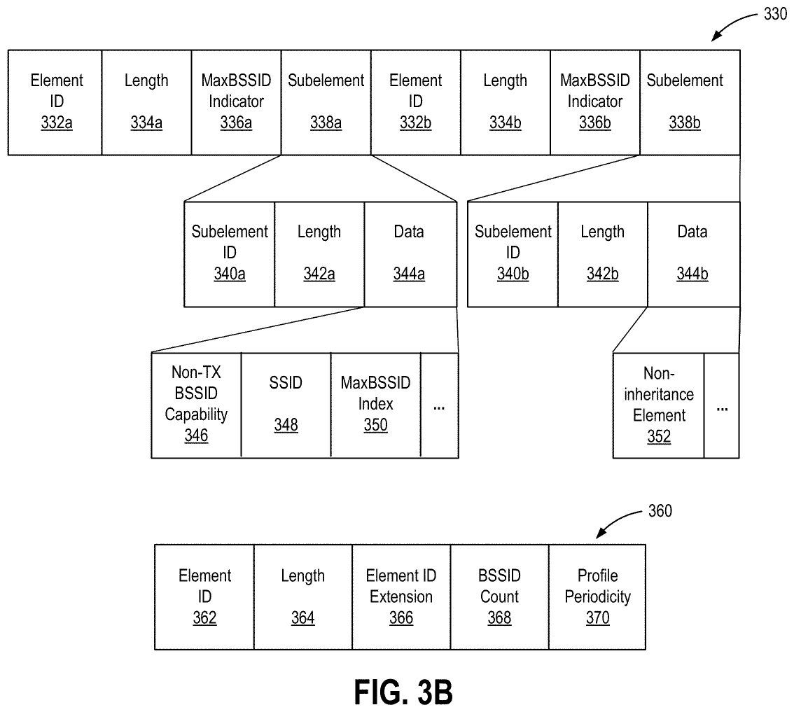

FIG. 3A depicts a block diagram of an example MBSSID beacon 300 and a block diagram of an example MBSSID element 320, in accordance with one embodiment. In this example, MBSSID beacon 300 can include an MBSSID for VAPs provided by an AP. The MBSSID combines the BSSIDs of the VAPs by providing elements describing a transmitted VAP and elements describing non-transmitted VAPs in terms of what is inherited or not inherited from the transmitted VAP. In this example, the MBSSID beacon 300 can include transmitted VAP elements 302a, 302b and non-transmitted VAP elements 304. Transmitted VAP elements 302a, 302b can include information elements associated with a transmitted VAP in the MBSSID beacon. The MAC header 312 can correspond to the MAC header of the transmitted VAP. The information elements 314a, 314b, 314c, 314d can include various characteristics of the transmitted VAP. The non-transmitted VAP elements 304 can include MBSSID elements 316a, 316b, 316c associated with non-transmitted VAPs. MBSSID elements 316a, 316b, 316c can include various characteristics of the non-transmitted VAPs. The MBSSID elements 316a, 316b, 316c describe the characteristics of the non-transmitted VAPs in terms of what is inherited and not inherited from the characteristics of the transmitted VAP, as provided in information elements 314a, 314b, 314c, 314d.

As illustrated in FIG. 3A, MBSSID element 320 can be implemented as MBSSID elements 316a, 316b, 316c in MBSSID beacon 300. In this example, MBSSID element 320 can include element ID 322, length 324, MaxBSSID indicator 326, and subelements 328. Element ID 322 provides the ID of MBSSID element 320. Length 324 provides the length of MBSSID element 320. MaxBSSID indicator 326 provides the maximum number of supported BSSIDs. Subelements 328 provide the characteristics of the non-transmitted VAP corresponding to element ID 322. In this example, element ID 322, length 324, and MaxBSSID indicator 326 are octets, and subelements 328 has variable length.

FIG. 3B depicts a block diagram of two example MBSSID elements 330 and a block diagram of an example MBSSID config element 360, in accordance with one embodiment. In this example, MBSSID elements 330 includes two MBSSID elements. The two MBSSID elements can be a part of an MBSSID beacon, such as MBSSID beacon 300 of FIG. 3A. Element IDs 332a, 332b that provides the IDs of the two MBSSID elements. Lengths 334a, 334b provide the lengths of the two MBSSID elements. MaxBSSID indicators 336a, 336b provide the maximum number of supported BSSIDs. Subelement 338a provides the characteristics of a non-transmitted VAP corresponding to element ID 332a. Subelement 338a can include subelement ID 340a, length 342a, and data 344a. Subelement ID 340a provides the ID of subelement 338a. Length 342a provides the length of subelement 338a. Data 344a provides the characteristics of the non-transmitted VAP corresponding to element ID 332a. In this example, data 344a provides an inherited capability of the non-transmitted VAP, and the inherited capability is provided by the non-transmitted (Non-TX) BSSID capability 346, SSID 348, and MaxBSSID index 350. In this example, subelement 338b provides the characteristics of a non-transmitted VAP corresponding to element ID 332b. Subelement 338b can include subelement ID 340b, length 342b, and data 344b. Subelement ID 340b provides the ID of subelement 338b. Length 342b provides the length of subelement 338b. Data 344b provides the characteristics of the non-transmitted VAP corresponding to element ID 332b. In this example, 344b provides a non-inherited capability of the non-transmitted VAP, and the non-inherited capability is provided in the non-inheritance element 352.

An MBSSID can also include MBSSID config elements, such as MBSSID config element 360. As illustrated in FIG. 3B, MBSSID config element 360 can include element ID 362, length 364, element ID extension 366, BSSID count 368, and profile periodicity 370. Element ID 362 identifies an element to be configured by MBSSID config element 360. Length 364 provides the length of MBSSID config element 360. Element ID extension 366 provides additional elements to be configured, for example, if element ID 362 is set to 255. BSSID count 368 provides a total number of active BSSIDs in an MBSSID. Profile periodicity 370 indicates a minimum number of beacon frames to discover all non-transmitted VAPs in an MBSSID. For example, if profile periodicity 370 is set to four, then a client device can wait for at least four beacon intervals to receive an MBSSID.

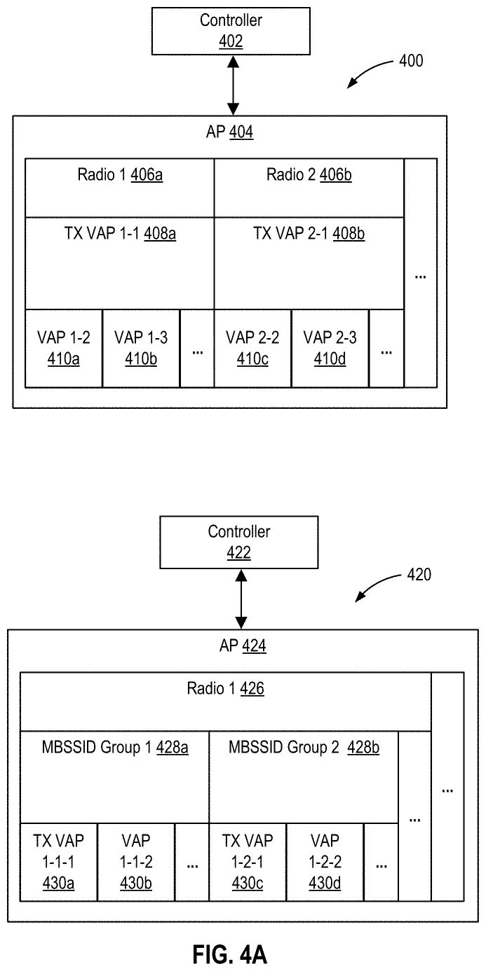

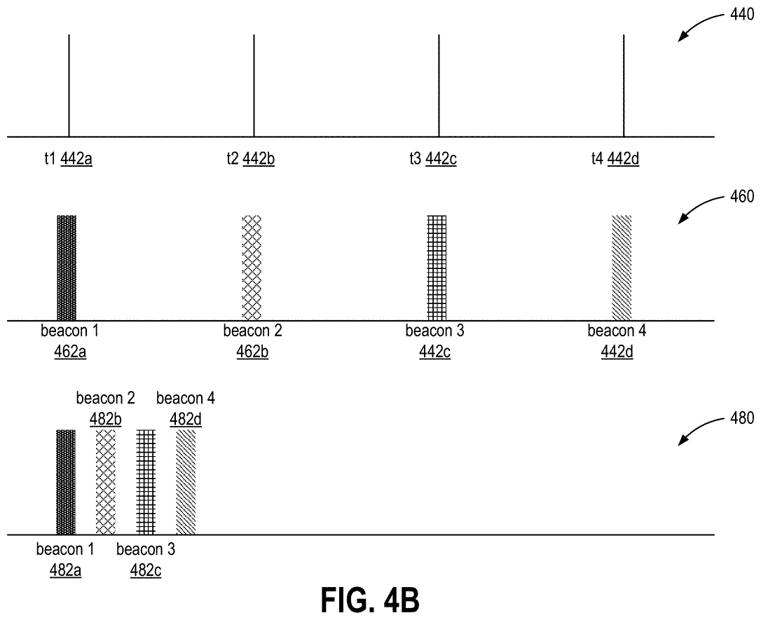

FIG. 4A depicts a block diagram of example VAP configurations 400, 420, in accordance with one embodiment. VAP configuration 400 includes an AP controller 402 and an AP 404. AP 404 includes two radios, radio 1 406a and radio 2 406b. In this example, radio 1 406a provides an MBSSID that combines TX VAP 1-1 408a, VAP 1-2 410a, and VAP 1-3 410b. The MBSSID uses TX VAP 1-1 408a as the transmitted VAP. The BSSIDs of VAP 1-2 410a and VAP 1-3 410b are included in the MBSSID as non-transmitted VAPs based on their inheritance from TX VAP 1-1 408a. Radio 2 406b provides an MBSSID that combines TX VAP 2-1 408b, VAP 2-2 410c, and VAP 2-3 410d. The MBSSID uses TX VAP 2-1 408b as the transmitted VAP. The BSSIDs of VAP 2-2 410c and VAP 2-3 410d are included in the MBSSID as non-transmitted VAPs based on their inheritance from TX VAP 2-1 408b.

VAP configuration 420 includes an AP controller 422 and an AP 424. AP 424 includes one radio, radio 1 426. In this example, radio 1 426 provides two MBSSIDs, MBSSID group 1 428a and MBSSID group 2 428b. MBSSID group 1 428a uses TX VAP 1-1-1 430a as the transmitted VAP. VAP 1-1-2 430b is included in MBSSID group 1 428a as a non-transmitted VAP based on its inheritance from TX VAP 1-1-1 430a. MBSSID group 2 428b uses TX VAP 1-2-1 430c as the transmitted VAP. VAP 1-2-2 430d is included in MBSSID group 2 428b as a non-transmitted VAP based on its inheritance from TX VAP 1-2-1430c. As illustrated in the example configurations 400, 420, use of multiple MBSSIDs can allow for efficient use of a radio in an AP.

FIG. 4B depicts a timing diagram of example beacon intervals 440, a timing diagram of an example broadcast of beacon frames associated with an MBSSID 460, and a timing diagram of an example broadcast of beacon frames associated with multiple MBSSIDs 480, in accordance with one embodiment. In this example, the beacon intervals 440 can include a first time, t1 442a, a second time, t2 442b, a third time, t3 442c, and a fourth time, t4 442d. T1 442a, t2 442b, t3 442c, and t4 442d can correspond to regular intervals where a beacon is broadcast by an AP. In this example, the beacon frames associated with an MBSSID 460 are broadcast at these regular intervals. In cases where an MBSSID combines multiple VAPs, the MBSSID can span multiple beacons. In this example, MBSSID 460 spans four beacon frames. Beacon 1 462a is broadcast at t1 442a. Beacon 2 462b is broadcast at t2 442b. Beacon 3 462c is broadcast at t3 442c. Beacon 4 442d is broadcast at t4 442d. Thus, broadcasting MBSSID 460 takes a time period from t1 442a to t4 442d. In this example, the beacon frames associated with multiple MBSSIDs 480 can be broadcast at different timings. Beacon 1 482a for a first MBSSID can be broadcast at t1 442a. Beacon 2 482b for a second MBSSID, beacon 3 482c for a third MBSSID, and beacon 4 482d for a fourth MBSSID can be broadcasted before t2 442b. As illustrated in this example, use of multiple MBSSIDs can allow for flexible broadcasting of MBSSID information.

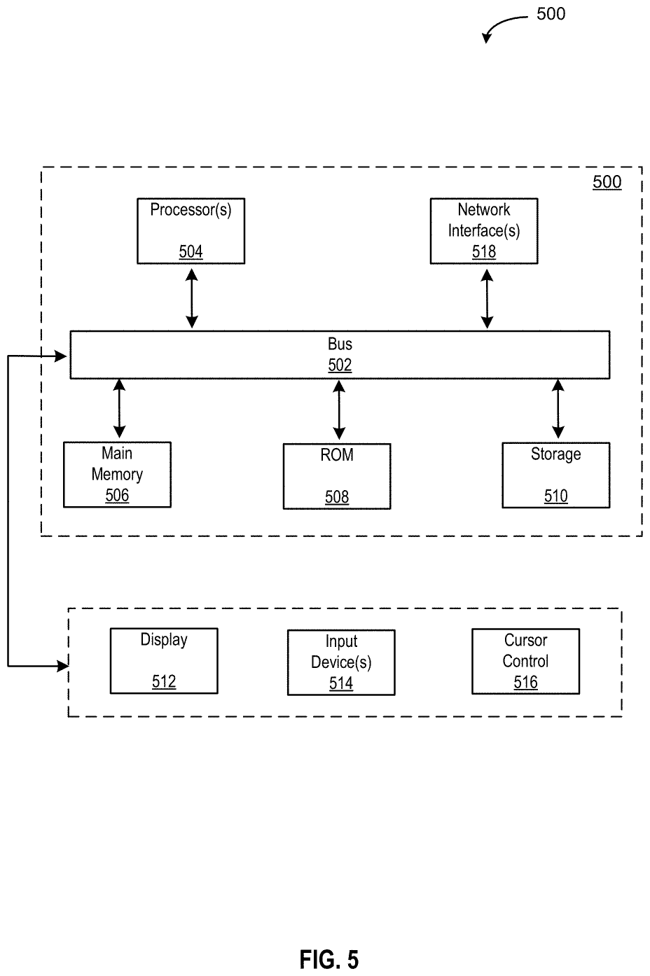

FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes a communication interface 518 coupled to bus 502. Network interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
determining a set of virtual access points (VAPs) associated with an access point (AP);
determining a first subset of VAPs and a second subset of VAPs based on one or more characteristics that separates the first subset of VAPs from the second subset of VAPs;
generating a first multiple basic service set identifier (MBSSID) associated with the first subset of VAPs and a second MBSSID associated with the second subset of VAPs; and
broadcasting the first MBSSID and the second MBSSID.

2. The method of claim 1, wherein the one or more characteristics includes a media access control (MAC) capability, the first subset of VAPs supports the MAC capability, and the second subset of VAPs does not support the MAC capability.

3. The method of claim 1, wherein the one or more characteristics includes priorities associated with the set of VAPs and the first subset of VAPs is associated with a higher priority than the second subset of VAPs.

4. The method of claim 1, wherein the one or more characteristics includes a mesh capability, the first subset of VAPs supports the mesh capability, and the second subset of VAPs does not support the mesh capability.

5. The method of claim 1, wherein the one or more characteristics includes network zones associated with entities, the first subset of VAPs is associated with a first network zone associated with a first entity, and the second subset of VAPs is associated with a second network zone associated with a second entity.

6. The method of claim 1, wherein the one or more characteristics includes a broadcast target wake time (BTWT) session parameter, the first subset of VAPs is associated with a first BTWT session parameter, and the second subset of VAPs is associated with a second BTWT session parameter.

7. The method of claim 6, wherein the first MBSSID is associated with a first broadcast interval based on the first BTWT session parameter, the second MBSSID is associated with a second broadcast interval based on the second BTWT session parameter and the broadcasting the first MBSSID and the second MBSSID comprises:
broadcasting the first MBSSID based on the first broadcast interval; and
broadcasting the second MBSSID based on the second broadcast interval.

8. The method of claim 1, wherein the broadcasting the first MBSSID and the second MBSSID comprises:
broadcasting the first MBSSID for a first number of beacon intervals based on a first number of VAPs in the first subset of VAPs;
broadcasting the second MBSSID for a second number of beacon intervals based on a second number of VAPs in the second subset of VAPs; and
providing a Delivery Traffic Indication Message (DTIM) interval wherein multicast data is broadcast based on the first number of beacon intervals and the second number of beacon intervals.

9. The method of claim 1, further comprising:
determining a change to the one or more characteristics associated with a VAP in the first subset of VAPs;
modifying the first MBSSID based on the change to the one or more characteristics associated with the VAP, wherein the second MBSSID is not modified.

10. The method of claim 1, wherein the providing the first MBSSID and the second MBSSID comprises broadcasting the first MBSSID and the second MBSSID within a beacon interval.

11. An access point (AP) comprising:
a processor; and
a memory operatively connected to the processor, and including computer code that when executed, causes the AP to:
determine a set of virtual access points (VAPs) associated with the AP;
determine a first subset of VAPs and a second subset of VAPs based on one or more characteristics that separates the first subset of VAPs from the second subset of VAPs;
generate a first multiple basic service set identifier (MBSSID) associated with the first subset of VAPs and a second MBSSID associated with the second subset of VAPs; and
broadcast the first MBSSID and the second MBSSID.

12. The AP of claim 11, wherein the one or more characteristics includes a media access control (MAC) capability, the first subset of VAPs supports the MAC capability, and the second subset of VAPs does not support the MAC capability.

13. The AP of claim 11, wherein the one or more characteristics includes priorities associated with the set of VAPs and the first subset of VAPs is associated with a higher priority than the second subset of VAPs.

14. The AP of claim 11, wherein the one or more characteristics includes a mesh capability, the first subset of VAPs supports the mesh capability, and the second subset of VAPs does not support the mesh capability.

15. The AP of claim 11, wherein the one or more characteristics includes network zones associated with entities, the first subset of VAPs is associated with a first network zone associated with a first entity, and the second subset of VAPs is associated with a second network zone associated with a second entity.

16. The AP of claim 11, wherein the one or more characteristics includes a broadcast target wake time (BTWT) session parameter, the first subset of VAPs is associated with a first BTWT session parameter, and the second subset of VAPs is associated with a second BTWT session parameter.

17. The AP of claim 16, wherein the first MBSSID is associated with a first broadcast interval based on the first BTWT session parameter, the second MBSSID is associated with a second broadcast interval based on the second BTWT session parameter and the broadcast the first MBSSID and the second MBSSID comprises:
broadcast the first MBSSID based on the first broadcast interval; and
broadcast the second MBSSID based on the second broadcast interval.

18. The AP of claim 11, wherein the broadcast the first MBSSID and the second MBSSID comprises:
broadcast the first MBSSID for a first number of beacon intervals based on a first number of VAPs in the first subset of VAPs;
broadcast the second MBSSID for a second number of beacon intervals based on a second number of VAPs in the second subset of VAPs; and
providing a Delivery Traffic Indication Message (DTIM) interval wherein multicast data is broadcast based on the first number of beacon intervals and the second number of beacon intervals.

19. The AP of claim 11, wherein the computer code further causes the AP to:
determine a change to the one or more characteristics associated with a VAP in the first subset of VAPs;
modify the first MBSSID based on the change to the one or more characteristics associated with the VAP, wherein the second MBSSID is not modified.

20. The AP of claim 11, wherein the providing the first MBSSID and the second MBSSID comprises broadcasting the first MBSSID and the second MBSSID within a beacon interval.
